(19) United States
(12) Patent Application Publication
(10) Pub. No.: US 2019/0034650 A1
(43) Pub. Date: Jan. 31, 2019

(54) Systems and methods for editing,storing,sharing and displaying digital notes

(71) Applicants: Jean-Philippe Faure, Grenoble (FR); Edith Berard, Grenoble (FR)

(72) Inventors: Jean-Philippe Faure, Grenoble (FR); Edith Berard, Grenoble (FR)

(73) Assignee: Progilon SARL, Grenoble (FR)

(21) Appl. No.: 16/019,648

(22) Filed: Jun. 27, 2018

Related U.S. Application Data
(60) Provisional application No. 62/527,083, filed on Jun. 30, 2017.

(51) Int. Cl. G06F 21/62; G06F 21/31; G06F 17/24; G06F 3/0483; G06F 17/30

(52) U.S. Cl. CPC G06F 21/6209; G06F 21/31; G06F 17/30961; G06F 3/0483; G06F 17/24

(57) ABSTRACT

A system and methods for editing, storing, sharing notes and, arranging and displaying a plurality of notes according to hierarchical trees of notes. A note comprises a content, one or more members and optionally parent notes. A member of a note is a user of the system who have access to the note. A parent note of a note specifies a parent child relationship between two notes within a hierarchical tree of notes. The system and methods described herein allow a user to create a note, to specify which users have access to a note, to revise the content and the members of a note and to delete a note. The system and methods described herein further allow a user to arrange the notes to which he/she has access in a hierarchical tree of notes, said notes being shared with different users.

### BACKGROUND INFORMATION

### 1. Field

The present invention is in the technical field of computer-implemented collaborative tools. More particularly, the present invention is in the technical field of computer-implemented collaborative tools enabling a user to create notes, edit notes, store notes, share notes with other users and arrange notes in hierarchical trees of notes. A note can include any kind of data including but not limited to text, pictures, music and any type of files.

### 2. Background

One of the problems with conventional computer-implemented collaborative tools enabling users to store and to share notes is that the stored notes are usually shared among predefined groups of users. Using predefined groups of users for sharing stored notes is not flexible. In many cases, during a collaborative work, a user would like to share a specific note with a specific list of users that does not correspond to a predefined group of users. In these cases conventional computer-implemented collaborative tools usually require the user to create a new group of users corresponding to the said specific list of users before sharing the note with the said new group of users. This adds a necessary operation before sharing the note. This also increases the number of predefined groups of users and the complexity to manage them.

Another problem with the conventional tools is that, while the notes are usually arranged in directories and subdirectories, all notes contained in a directory and its subdirectories are typically shared within a same group of users. Sharing the content of a directory and its subdirectories within a same group of users is not flexible. In many cases it is useful to arrange notes according to a hierarchical tree of notes and, at the same time, to enable to share each note with its own list of users. For example, it is useful to be able, within a hierarchical tree of notes, to have, arranged under a same parent note, several child notes shared with different users. Such ability may be used for breaking down a main task described in a parent note in several parallel sub tasks described in several child notes and delegated to different users, said users having no need to be aware of other parallel sub tasks. For example, it is also useful to be able, within a hierarchical tree of notes, to add among shared notes personal notes not shared with other users. A personal note may be used for following up work progress on a task described in a note. Conventional tools typically do not enable, at the same time, to display notes to a user arranged according to a hierarchical tree of notes, and to individually decide for each note the list of users who have access to a note.

### SUMMARY OF THE INVENTION

The invention relates to a system and methods for editing, storing and sharing notes and for arranging and displaying notes according to hierarchical trees of notes. A note may be used for, but not limited for, describing a task to do, recording an event, storing files or describing a title of a subtree of a tree of notes. A note comprises a content, members and parent notes. The members of a note are the users of the system who have access to the note. The parent notes of a note specify parent/child relationships between notes. The system and the methods described herein allow a user to create a note, to specify which users have access to a note, to revise the content and the members of a note and to delete a note. The system and the methods described herein further allow a user to arrange the notes to which s/he has access in hierarchical trees of notes, said notes being shared with different users.

### BRIEF DESCRIPTION OF THE DRAWINGS

FIG. 1 is an illustration of a system and methods for editing, storing, sharing and arranging notes in the form of a block diagram in accordance with an illustrative embodiment.

FIG. 2 is an illustration of a method in the form of a flow chart for generating a tree of notes to which a list of users has access in accordance with an illustrative embodiment.

FIG. 3 is an illustration of a method in the form of a flow chart for extracting from a database the list of notes to which a list of users has access in accordance with an illustrative embodiment.

FIG. 4 is an illustration of a method in the form of a flow chart for generating a tree of notes from a list of notes comprising root notes and child notes in accordance with an illustrative embodiment.

FIG. 5 is a simplified block diagram illustrating components of a networked computing environment that may be used in accordance with an embodiment of the present invention.

FIG. 6 is an illustration of a navigation interface in the form of a sample user interface in accordance with an illustrative embodiment.

FIG. 7 is an illustration of an interface for creating or revising a note in the form of a sample user interface in accordance with an illustrative embodiment.

### DETAILED DESCRIPTION OF THE INVENTION

The present invention is a system and methods for editing, storing, sharing, arranging and displaying notes in a client/server environment. In the following description, for the purposes of explanation, numerous specific details are set forth in order to provide an understanding of the present invention. It will be apparent, however, to one skilled in the art that the present invention may be practiced without some of these specific details.

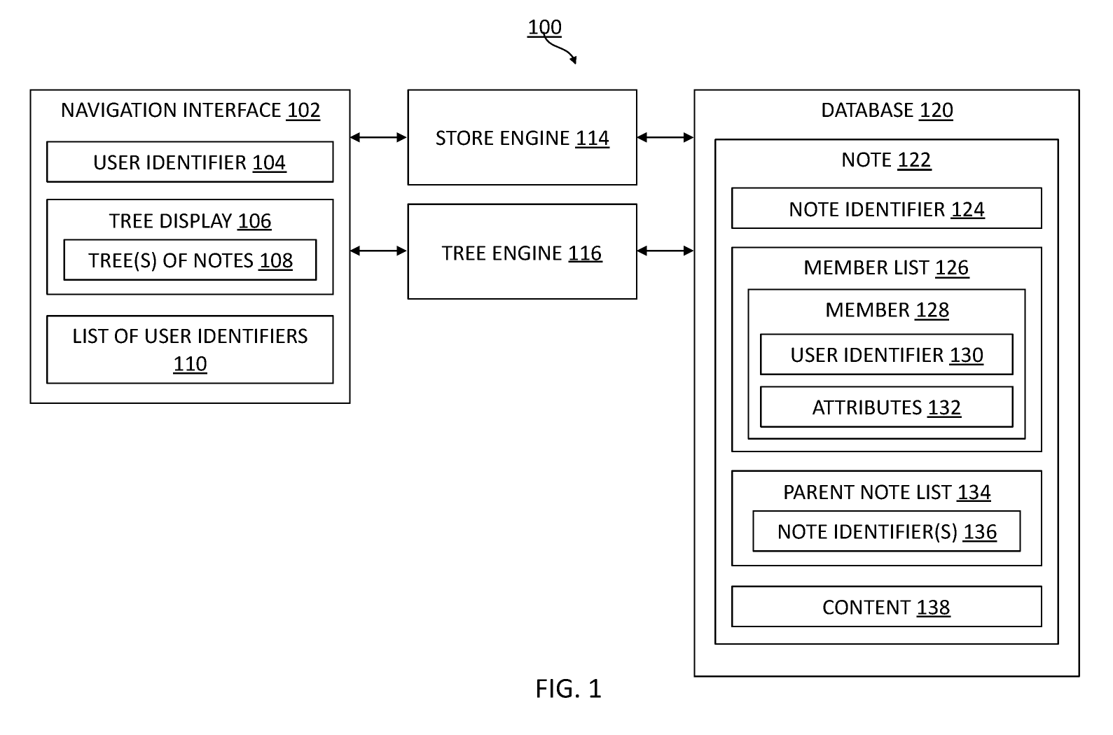

FIG. 1 is an illustration of a system and methods for editing, storing, sharing, arranging and displaying notes in the form of a block diagram in accordance with an illustrative embodiment. In this illustrative example, system 100 includes store engine 114, tree engine 116, database 120 and a plurality of navigation interfaces 102.

Note Database.

Database 120 stores and provides access to a number of notes 122. A note 122 includes note identifier 124, member list 126, parent note list 134 and content 138. Note identifier 124 identifies a note 122 in system 100. For the purposes of this description a user of system 100 who has access to a note is also referred to as a member of a note. Member list 126 includes one or more members 128 of note 122. Member 128 includes user identifier 130 that identifies a user of system 100 and attributes 132. In an illustrative example an attribute 132 is used for recording that a member 128 is the member who created note 122. In another illustrative example attributes 132 are used for specifying permissions granted to member 128 for performing operations on note 122 such as, but not limited to, revising the content of the note, or adding and removing other members of the note. Parent note list 134 identifies the notes that are parent notes of note 122. Parent note list 134 includes zero or more note identifiers 136. Note identifier 136 identifies a note in system 100. Parent note lists are used by tree engine 116 for generating trees of notes 108. Content 138 may include any kind of information that can be stored in a computer system. Content 138 may include, but not limited to, a title, a description, dates, and file(s).

Navigation Interface.

Navigation interface 102 includes user identifier 104 that identifies a user of system 100. Navigation interface 102 is a user interface that allows a user identified by user identifier 104 to interact with notes 122 of which said user is a member.

A User Requesting to Display a Tree of Notes.

Navigation interface 102 allows a user to request to display a tree of notes of which said user is a member. A user requesting to display a tree of notes of which said user is a member causes navigation interface 102 to request tree engine 116 to return a tree of notes comprising one or more notes 122 of which user identified by user identifier 104 of said navigation interface 102 is a member. Said request includes user identifier 104. In response to receiving from navigation interface 102 a request to return a tree of notes tree engine 116 sends to navigation interface 102 a tree of notes 108 comprising notes of which user identified by user identifier 104 is a member. Navigation interface 102 includes tree display 106 that displays one or more trees of notes 108 received from tree engine 116.

Optionally navigation interface 102 allows user identified by user identifier 104 to select a note in a tree of notes 108 displayed by tree display 106 and to request tree engine 116 to return a tree of notes 108 comprising only child notes of said selected note. Optionally navigation interface 102 allows user identified by user identifier 104 to specify a list of user identifiers 110 that identify users of system 100 and to request tree engine 116 to return a tree of notes 108 comprising notes of which all users identified by user identifier 104 and the identifiers contained in list of user identifiers 110 are members.

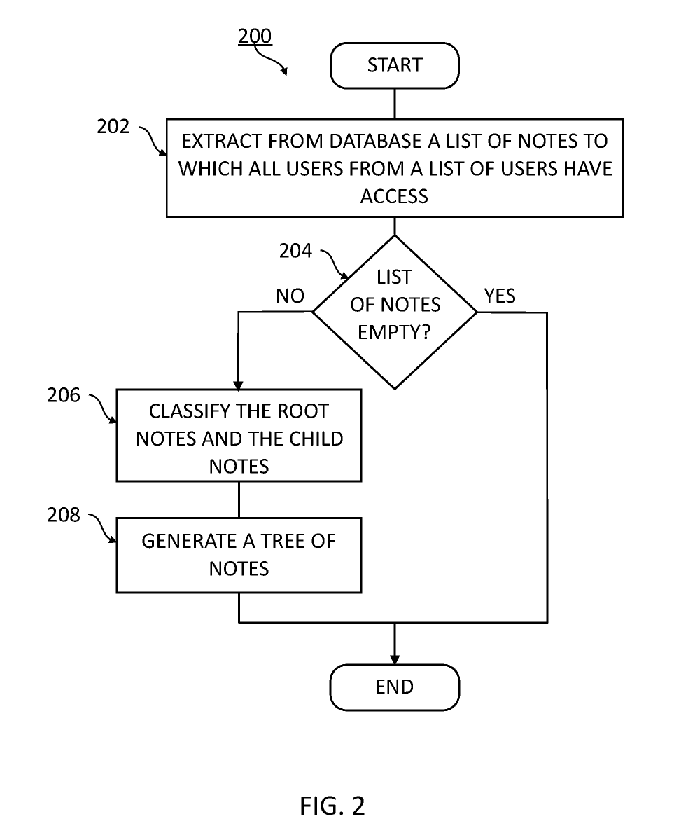

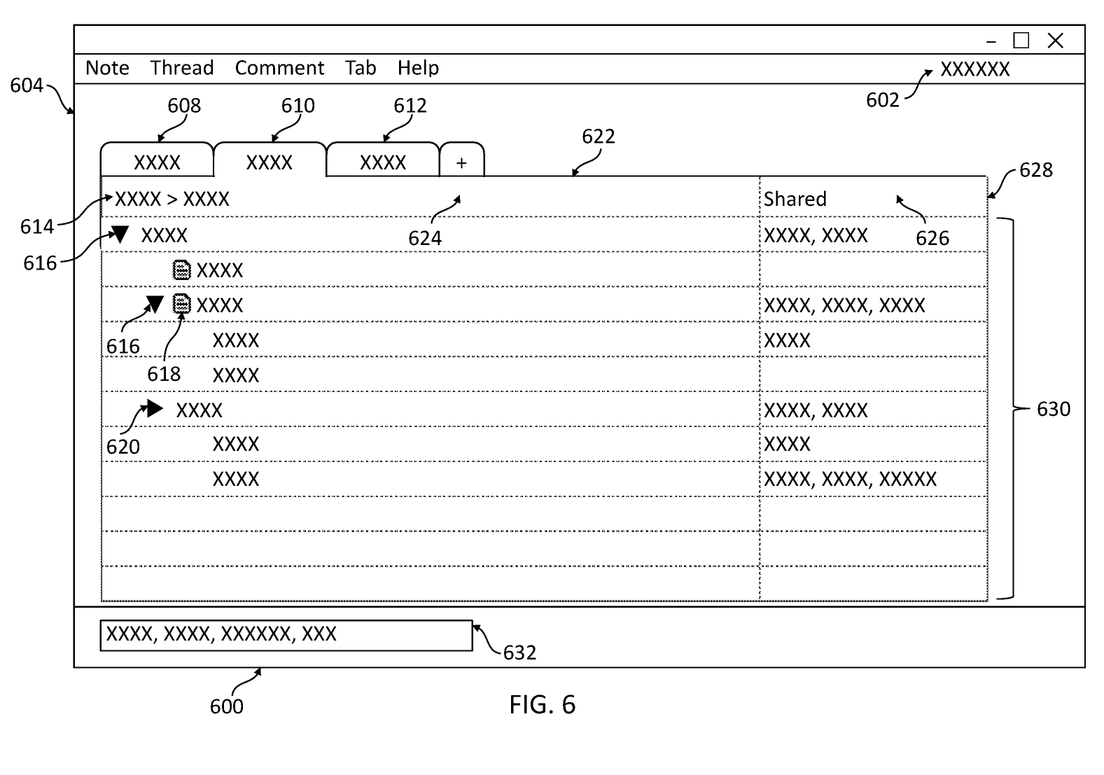

A tree of notes 108 is a collection of nodes, a node comprising a note, that can be used for displaying notes as a hierarchical tree indicative of parent/child relationships between notes displayed on the hierarchical tree. In an illustrative embodiment a tree of notes 108 is an ordered list of nodes, a node comprising a note 122 and a child rank. For the purpose of the description a node which comprised note is a child note of the note comprised in another node is also referred to as a child node of said another node. Said ordered list of nodes is ordered in a way that the child nodes of a parent node are listed underneath said parent node. A method for generating a tree of notes 108 by tree engine 116 is described below with reference to FIGS. 2, 3 and 4. In this illustrative embodiment tree display 106 displaying a tree of notes 108 consists in displaying said ordered list of nodes in a table, a row of said table displaying a node. Table 622 of FIG. 6 is an embodiment of said table. In one embodiment the child rank comprised in a node is used by tree display 106 for indenting, in a row, the display of the content of the note comprised in said node.

A User Creating a Note.

Navigation interface 102 allows a user to enter a new note comprising content that may include, but not limited to, a title, a description, dates, and files and comprising user identifier 104 that identifies a member of the new note. A new note may further comprise additional user identifiers that identify additional members of said new note. Navigation interface 102 also allows a user to select a note in a tree of notes 108 prior to entering a new note to be a parent note of said new note. A user creating a new note causes navigation interface 102 to request store engine 114 to store a new note in database 120. Said request includes user identifier 104 that identifies a user of system 100 who initiated the request and includes a note content. Said request may also include other user identifiers that identify additional members of new note and may also include a note identifier that identifies a parent note of new note. In response to receiving from navigation interface 102 said request store engine 114 1) creates a new note 122 in database 120; 2) assigns a note identifier 124 to said new note; 3) stores user identifier 104 and other user identifiers included in the request in member list 126 of said new note 122; 4) stores the note content received in the request in content 138 of said new note 122 and 5) if the request includes a note identifier that identifies a parent note of new note, stores said note identifier in parent note list 134 of said new note 122.

In a specific embodiment store engine 114 adds to member 128 which user identifier 130 matches user identifier 104 received in the request an attribute 132 specifying that member 128 is the member that created said new note 122.

A User Re-Arranging a Note in a Tree of Notes.

Navigation interface 102 allows a user to select a note in a tree of notes 108 and move it to a different place in the tree of notes 108. A user moving a note in a tree of notes 108 causes navigation interface 102 to request store engine 114 to change a parent note of a note stored in database 120. Said request includes user identifier 104 that identifies a user of system 100 who initiated the request and includes a note identifier that identifies a note selected by said user. Said request may also include a note identifier that identifies a current parent note of selected note and may also include a note identifier that identifies a new parent note of selected note. In response to receiving from navigation interface 102 said request store engine 114 1) if the request includes a note identifier that identifies a current parent note of selected note, removes said note identifier from parent note list 134 of note 122 which note identifier 124 matches the note identifier that identifies selected note included in the request; 2) if the request includes a note identifier that identifies a new parent note of selected note, adds said note identifier to parent note list 134 of said note 122.

In a specific embodiment store engine performs said steps 1 and 2 if and only if said selected note and said current parent note of selected note were not created by a same user different from the user identified by user identifier 104. This conditional processing prevents a user to break a parent/child relationship between a parent note and a child note that were both created by another user.

It should be noted that a user moving a note in a tree of notes actually causes the entire subtree that comprises said note and all recursively defined child notes of said note and of which said user is a member to move.

A User Revising the Content of a Note.

Navigation interface 102 allows a user to select a note in a tree of notes 108 and to revise the content of selected note. Revised content may include but not limited to, a title, a description, dates, and files. A user revising the content of a note causes navigation interface 102 to request store engine 114 to revise the content of a note in database 120. Said request includes user identifier 104 that identifies a user of system 100 who initiated the request, includes a note identifier that identifies a note selected by said user and includes a note content. In response to receiving from navigation interface 102 said request store engine 114 updates content 138 of note 122 which note identifier 124 matches the note identifier that identifies selected note included in the request with note content included in the request.

In a specific embodiment only a member who created a note is allowed to revise the content of said note. In another embodiment the authorization for a member of a note to revise the content of said note depends on the permissions specified in attributes 132 of said member.

A User Revising the Members of a Note Other than him/Herself.

Navigation interface 102 allows a user to select a note in a tree of notes 108 and to revise the list of members of selected note other than removing him/herself. A user revising the list of members other than removing him/herself of a note causes navigation interface 102 to request store engine 114 to revise the list of members of a note in database 120. Said request includes user identifier 104 that identifies a user of system 100 who initiated the request and includes a note identifier that identifies a note selected by said user. Said request may also include other user identifiers that identify members of selected note. In response to receiving from navigation interface 102 said request store engine 114 updates member list 126 of note 122 which note identifier 124 matches the note identifier that identifies selected note included in the request. Store engine 114 updating member list 126 of said note 122 consists in 1) store engine 114 adding to said member list 126 the user identifiers that identify members of selected note included in the request and that are not included in said member list 126 and 2) store engine 114 adding to each member 128 of said member list 126 which user identifier 130 is not included in the request an attribute 132 specifying that content of said note 122 shall be hidden to said each member 128. Optionally said attribute 132 also records user identifier 104 that identifies the user that caused the content to be hidden to said member 128. It should be noted that said each member 128 remains a member of said note 122.

In a specific embodiment only a member who created a note is allowed to revise the list of members of said note other than removing him/herself. In another embodiment the authorization for a member of a note to revise the list of members of said note other than removing him/herself depends on the permissions specified in attributes 132 of said member.

Displaying a Note which Content is Hidden to a Member.

If a user requests to display a tree of notes and if the content of a note of said tree of notes shall be hidden to said user tree display 106 displays instead of the content of said note and the list of members of said note an informative text indicating that the content of said note is hidden and optionally indicating a user identifier identifying the user who caused the content to be hidden. Further, said user is not allowed to revise the content of said note and is not allowed to revise the list of members of said note other than removing him/herself.

A User Deleting a Note in a Tree of Notes.

Navigation interface 102 allows a user to select a note in a tree of notes 108 and to delete said note from said tree of notes 108. A user deleting a note in a tree of notes causes navigation interface 102 to request store engine 114 to remove himself/herself from the list of members of a note in database 120. Said request includes user identifier 104 that identifies a user of system 100 who initiated the request and includes a note identifier that identifies a note selected by said user. In response to receiving from navigation interface 102 said request store engine 114 removes member 128 which identifier matches user identifier 104 included in the request from member list 126 of note 122 which note identifier 124 matches the note identifier that identifies selected note included in the request. It should be noted that members of said note 122 other than member identified by user identifier 104 remain members of said note 122.

In a specific embodiment, store engine 114 further adds to content 138 of said note 122 a comment indicating that user identified by user identifier 104 included in the request has removed him/herself as member of said note 122.

In an embodiment a user deleting a note in a tree of notes causes the entire subtree that comprises said note and all recursively defined child notes of said note and of which said user is a member to be deleted by said member.

A User Deleting all Members of a Note and Said Note in a Tree of Notes.

In one embodiment navigation interface 102 allows a user, in a single operation, to select a note in a tree of notes 108, to remove all members from the list of members of selected note other than him/herself and to delete said note from said tree of notes 108. Performing said single operation is equivalent to a user successively revising the members of a note other than him/herself, said revision being a deletion of all members other than him/herself, and deleting a note in a tree of notes, as described above.

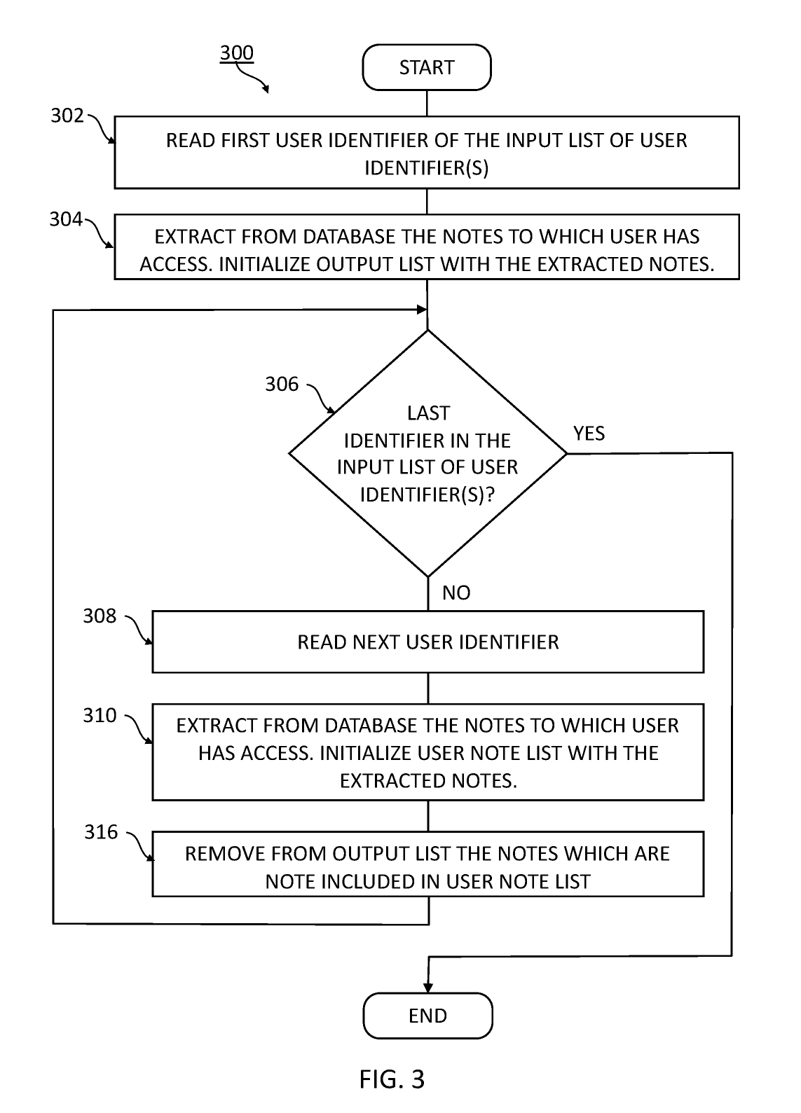

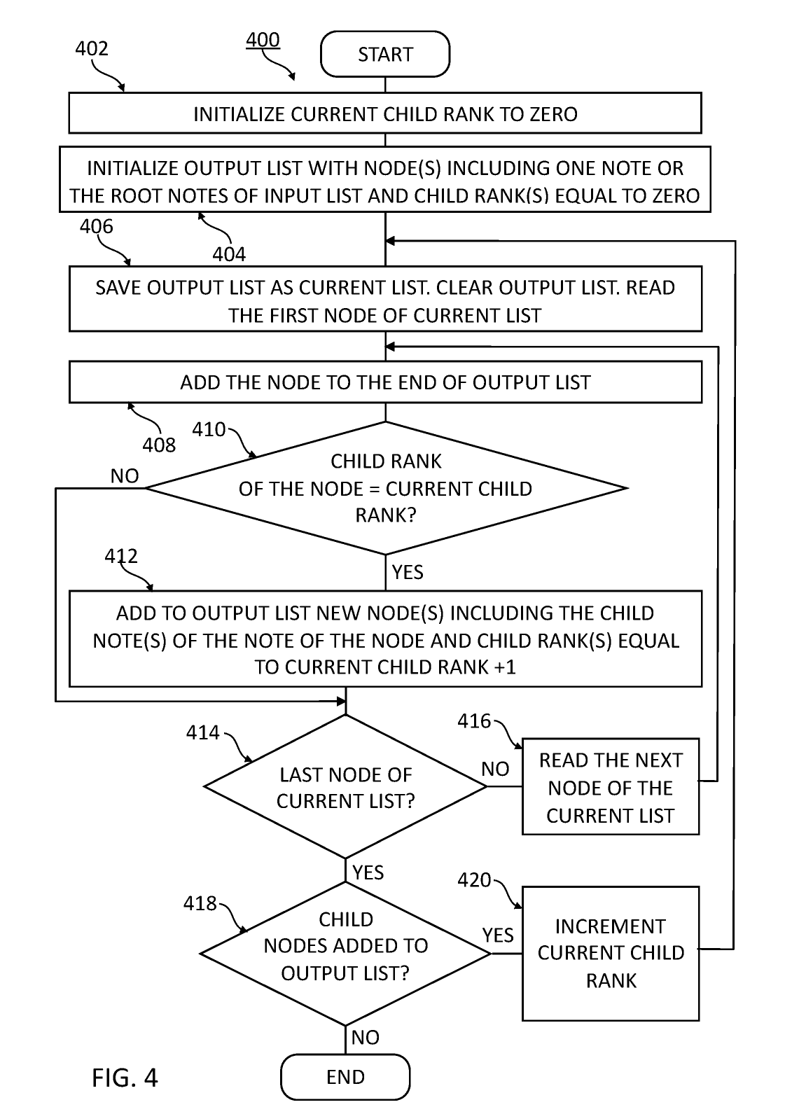

FIG. 2 is an illustration of a method in the form of a flow chart 200 for generating a tree of notes to which a list of users has access in accordance with an illustrative embodiment. In this illustrative example, described are the steps or operations that are performed by tree engine 116 for generating a tree of notes 108 from database 120 in FIG. 1. For the purposes of the description a note to which all users of a list of users identified by a list of user identifiers have access is also referred as to a note to which said list of users has access. Tree engine receives a list of user identifiers containing one or more user identifiers identifying users of system 100. Tree engine may also receive a subtree note identifier indicating to tree engine to generate a tree of notes including only the note identified by said note identifier and recursively defined child notes of said note. At step 202 tree engine extracts from database 120 the list of notes to which a list of users identified by the list of user identifiers received by tree engine has access and continues at decision 204. An example of method for extracting from a database 120 the list of notes to which a list of users has access is illustrated in FIG. 3. At decision 204 tree engine determines whether the list of notes extracted at step 202 is empty or not. If the list of notes extracted at step 202 is empty processing is completed and the generated tree of notes is empty, else tree engine continues at step 206. At step 206 tree engine classifies the notes extracted at step 202 in root notes and child notes and continues at step 208. Tree engine determines that a note is a child note if said note has one or more parent notes in the list of notes extracted in step 202. Tree engine determines that a note is a root note if said note is not a child note. At step 208 tree engine generates a tree of notes 108 from the root notes and the child notes classified at step 206. An example of method for generating a tree of notes 108 from a list of notes comprising root notes and child notes is illustrated in FIG. 4. After step 208 processing is completed.

FIG. 3 is an illustration of a method in the form of a flow chart 300 for extracting from a database the list of notes to which a list of users has access in accordance with an illustrative embodiment. In this illustrative example, described are the steps or operations that are performed by tree engine 116 for extracting from database 120 the list of notes 122 in FIG. 1 to which a list of users has access. Tree engine receives an input list of user identifiers identifying users of system 100. At step 302 tree engine reads the first user identifier of the input list of user identifiers and continues at step 304. At step 304 tree engine extracts from database 120 the notes to which user identified by user identifier read in step 302 has access, initializes an output list of notes with the extracted notes and continues at decision 306. Tree engine determines that a user has access to a note 122 of database 120 if the identifier that identifies said user is included in member list 126 of said note 122. At decision 306 tree engine determines whether the user identifier read at step 302 or at step 308 is the last user identifier of the input list of user identifiers. If the user identifier read at step 304 or at step 308 is the last user identifier of the input list of user identifiers processing is completed, else tree engine continues at step 308. At step 308 tree engine reads the next user identifier in the input list of user identifiers and continues at step 310. At step 310 tree engine extracts from database 120 the notes to which user identified by user identifier read in step 308 has access, initializes a user note list with the extracted notes and continues at step 316. At step 316 tree engine removes from the output list of notes the notes which are not included in the user note list initialized at step 310 and continues at decision 306. When processing is completed the output list of notes includes the list of notes to which a list of users identified by the input list of user identifiers has access.

FIG. 4 is an illustration of a method in the form of a flow chart 400 for generating a tree of notes from a list of notes comprising root notes and child notes in accordance with an illustrative embodiment. In this illustrative example, described are the steps or operations that are performed by tree engine 116 for generating a tree of notes 108 from a list of notes comprising root notes and child notes. In an illustrative embodiment a tree of notes 108 is an ordered list of nodes, a node comprising a note 122 and a child rank. For the purpose of the description a node which comprised note is a child note of the note comprised in another node is also referred to as a child node of said another node. Said ordered list of nodes is ordered in a way that the child nodes of a parent node are listed underneath said parent node. The method illustrated in flowchart 400 is an iterative method. Tree engine initializes an output list of nodes with one or more nodes including one or more notes. At each iteration tree engine identifies the child nodes of the nodes included in the output list of nodes and insert them at the right location in the output list of nodes. Iterations continue until no child node is added to the output list of nodes.

Tree engine receives an input list of notes comprising root notes and child notes. Tree engine may also receive a subtree note identifier identifying a note in the input list of notes and indicating to tree engine to generate a tree of notes including only the note identified by said note identifier and recursively defined child notes of said note. At step 402 tree engine initializes current child rank to zero and continues at step 404. At step 404 tree engine 1) creates one node with the note identified by the subtree note identifier received by tree engine or creates nodes with the root notes included in the input list of notes if tree engine did not receive any subtree note identifier; 2) adds to each created node a child rank equal to the current child rank which is zero; 3) initializes an output list of nodes with the created nodes and 4) continues at step 406. At step 406 tree engine 1) saves the output list of nodes as the current list of nodes; 2) clears the output list of nodes; 3) reads the first node of the current list of nodes and 4) continues at step 408. At step 408 tree engine adds the node read at step 406 or at step 416 at the end of the output list of nodes and continues at decision 410. At decision 410 tree engine determines whether the child rank of the node added to the output list of nodes at step 408 is equal to the current child rank. If the child rank of the node added to the output list of nodes at step 408 is equal to the current child rank tree engine continues at step 412 otherwise tree engine continues at decision 414. At step 412 tree engine 1) extracts from the input list of notes the child notes of note 122 of the node added to the output list of nodes at step 408; 2) creates nodes with the extracted child notes; 3) adds to each created node a child rank equal to the current child rank plus one; 4) adds each created node at the end of the output list of nodes and 5) continues at decision 414. In a specific embodiment the nodes added at the end of the output list of nodes in above operation 4) are added in the order of the time of creation of their notes 122 in system 100. At decision 414 tree engine determines whether the node added to the output list of nodes at step 408 is the last node of the current list of nodes. If the node added to the output list of nodes at step 408 is the last node of the current list of nodes tree engine continues at decision 418, otherwise tree engine continues at step 416. At step 416 tree engine reads the next node of the current list of nodes and continues at step 408. At decision 418 tree engine continues at step 420 if nodes have been added to the output list of nodes at step 412 since the last time the current child rank was incremented at step 420, otherwise processing is completed. At step 420 tree engine increments the current child rank by one and continues at step 406. It should be noted that a same note of the input list of notes may be added to different nodes of the output list of nodes since a note of the input list of notes may have more than one parent note in the input list of notes. After processing is completed the output list of nodes is a tree of notes 108 comprising notes from the input list of notes received by tree engine. Each node includes a child rank that indicates its child rank in the hierarchy of the tree of notes. The child rank of a node can be used for indenting the display of the note of said node when displaying a tree of notes. In a specific embodiment tree engine may receive additional note identifiers and commands and may add additional nodes to a tree of notes or add additional information to the nodes included in a tree of notes according to said received additional note identifiers and commands. Said additional nodes or additional information can be used for the displaying of a tree of notes, indicating the displaying to display at a specific location within a tree of notes a form for entering a new note or a form for revising a note.

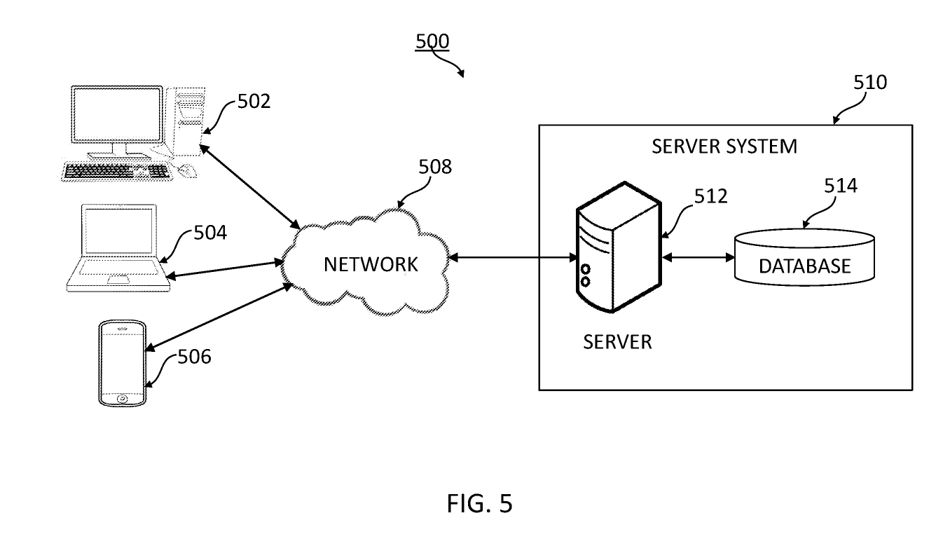

FIG. 5 is a simplified block diagram illustrating components of a networked computing environment 500 that may be used in accordance with an embodiment of the present invention. Networked computing environment 500 includes one or more of client computing devices 502, 504, 506, and a server system 510. Although networked computing environment 500 is shown with three client computing devices any number of client computing devices may be supported. Server system 510 includes a server 512 and a database 514. Although server system 510 is shown with one server and one database server system 510 may include any number of servers and any number of databases.

Client computing devices 502, 504, 506 may be general purpose personal computers (including, e.g., personal computers and/or laptop computers running various versions of Microsoft Windows and/or Apple Macintosh operating systems), cell phones, smart phones or tablets (running software such as Apple iOS, Microsoft Windows Mobile and being Internet, e-mail, SMS, Blackberry, or other communication protocol enabled), and/or workstation computers running any of a variety of commercially-available UNIX or UNIX-like operating systems (including without limitation the variety of GNU/Linux operating systems). Alternatively, client computing devices 502, 504, 506 may be any other electronic device capable of communicating over a network (e.g., network 508 described below) with server 512.

Server 512 may be a general purpose computer, specialized server computer (including, e.g., a LINUX server, UNIX server, mid-range server, mainframe computer, rack-mounted server, etc.), server farm, server cluster, or any other appropriate arrangement and/or combination. Server 512 may run an operating system including any of those discussed above, as well as any commercially available server operating system. Server 512 may also run any of a variety of server applications and/or mid-tier applications, including web servers, JAVA virtual machines, application servers, database servers, and the like. As indicated above, in one set of embodiments, server 512 is adapted to run one or more server and/or middle-tier components that are configured to receive and serve requests from client computing devices 502, 504, 506.

Database 514 may reside in a variety of locations. By way of example, database 514 may reside on a storage medium local to (and/or resident in) server 512. Alternatively, database 514 may be remote from server 512 and/or in communication (e.g., via network 508) with server 512. In one set of embodiments, database 514 may reside in a storage-area network (SAN) familiar to those skilled in the art.

Client computing devices 502, 504, 506, and server 512 are communicatively coupled via a network 508. Network 508 may be any type of network that can support data communications using any of a variety of commercially-available protocols, including without limitation TCP/IP, SNA, IPX, AppleTalk, and the like. Merely by way of example, network 508 may be a local area network (LAN), such as an Ethernet network, a Token-Ring network and/or the like; a wide-area network; a virtual network, including without limitation a virtual private network (VPN); the Internet; an intranet; an extranet; a public switched telephone network (PSTN); an infra-red network; a wireless network (e.g., a network operating under any of the IEEE 802.11 suite of protocols, the Bluetooth protocol known in the art, and/or any other wireless protocols); and/or any combination of these and/or other networks.

Database 514 is an illustrative embodiment of database 120 in FIG. 1. In a set of embodiments, server 512 is configured to run server components of a client-server application such as store engine 114 and tree engine 116 in FIG. 1. Further client computing devices 502, 504, 506 are configured to run client components of a client-server application such as navigation interface 102 in FIG. 1. In a specific embodiment a server component of said client-server application is a web server, a client component of said client-server application is a web browser and server 512 generates a tree of notes 108 in FIG. 1. in the form of a web page.

It may happen that a client computing device 502, 504, 506 is not able to communicate with server 512 over a period of time (e.g. when client computing device 502, 504, 506 is not connected to network 508). In a specific set of embodiments 1) a local database resides in a client computing device 502, 504, 506; 2) server 512 is configured to run a server component of a client-server application that returns copies of notes 122 of database 514 per request of a client computing device 502, 504, 506; and 3) a client computing device 502, 504, 506 is configured to run a client component that requests server 512 to provide copies of notes 122 of database 514 and to store copies of notes 122 of database 514 provided by server 512 in the local database that resides in said client computing device 502, 504, 506. Further a client computing device 502, 504, 506 is configured to run a client component of a client-server application such as tree engine 116 in FIG. 1. Tree engine 116 running on a client computing device 502, 504, 506 is used for generating trees of notes 108 from local database residing in said client computing device 502, 504, 506 for displaying by navigation interface 102 running on said client computing device 502, 504, 506. Further a client computing device 502, 504, 506 is configured to run a component that stores new notes created and notes revised on said client computing device 502, 504, 506 in the local database residing in said client computing device 502, 504, 506 until said client computing device 502, 504, 506 is able to communicate with server 512, to request server 512 to create in database 514 new notes corresponding to the new notes stored in said local database and to request server 512 to revise in database 514 notes corresponding to the revised notes stored in said local database. In this set of embodiments a user is able to interact with notes of which s/he is a member at anytime including when a client computing device 502, 504, 506 is not able to communicate with server 512.

FIG. 6 is an illustration of a navigation interface 600 in the form of a sample user interface in accordance with an illustrative embodiment. Navigation interface 600 is an illustrative embodiment of navigation interface 102 in FIG. 1. Navigation interface 600 comprises identifier 602 and tree window 604. Identifier 602 is an illustrative embodiment of user identifier 104 in FIG. 1. Tree window 604 is an illustrative embodiment of tree display 106 in FIG. 1. Tree window 604 comprises one or more tab panels 608, 610, 612 that display trees of notes comprising notes of which user identified by identifier 602 is a member. A tree of notes displayed in a tab panel 608, 610, 612 is an illustrative embodiment of a tree of notes 108 in FIG. 1.

In an illustrative embodiment a tree of notes 108 is an ordered list of nodes, a node comprising a note 122 and a child rank. A tab panel 608, 610, 612 comprises a table 622 with two columns 624, 626, a header 628 and a plurality of rows 630. The successive rows 630 of table 622, starting from the top row, comprise a display of the notes comprised in the successive nodes of said ordered list of nodes. A row 630 comprises a display of a note comprised in a node. Column 624 of said row 630 comprises the content of said note indented according to the child rank comprised in said node. Column 626 of said row 630 comprises identifiers identifying the members of said note. The order of the notes displayed in rows 630 and the indentations of the note contents displayed in column 624 of rows 630 indicates the parent/child relationships between the displayed notes.

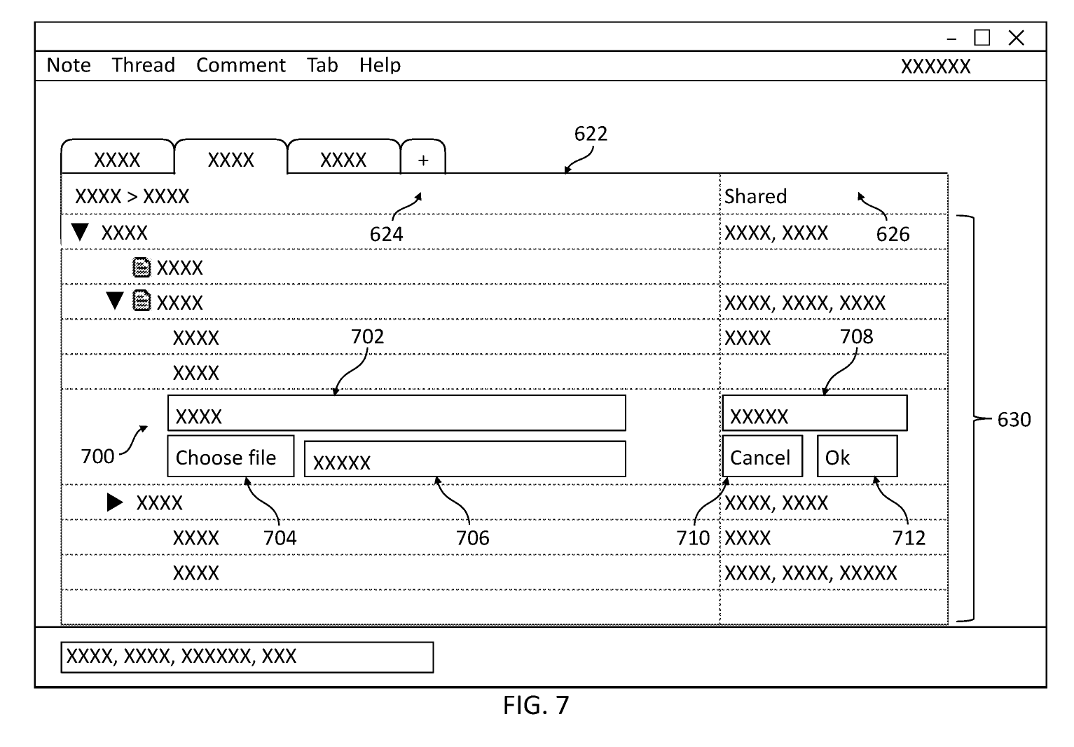

Navigation interface 600 allows a user to cause table 622 to be updated with a new row 630 comprising a form for creating a new note and added to the top of table 622. Navigation interface 600 allows a user to select a note displayed in table 622 and to cause table 622 to be updated with a new row 630 comprising a form for creating a new child note of said selected note and added underneath the row 630 displaying said selected note. Navigation interface 600 allows a user to select a note displayed in table 622 and to cause table 622 to be updated with a row 630 comprising a form for revising said selected note. A form for creating or revising a note is described below with reference to FIG. 7. Navigation interface 600 allows a user to select a note displayed in table 622 and to move the entire subtree that comprises said selected note and all recursively defined child notes of said note and of which said user is a member under another note displayed in table 622. Navigation interface 600 allows a user to select a note displayed in table 622 and to delete the entire subtree that comprises said selected note and all recursively defined child notes of said note and of which said user is a member from table 622.

Rows 630 may include in column 624 one or more buttons 616, 620 that allow a user of navigation interface 600 to expand or collapse a tree of notes displayed in table 622. In one embodiment a row 630 may also include in column 624 one or more icons 618 that allows a user of navigation interface 600 to download one or more files included in a note displayed in said row 630.

In one embodiment navigation interface 600 allows a user to select a note displayed in table 622 and to cause table 622 to be updated with the display of a subtree that comprises said selected note and all recursively defined child notes of said selected note and of which said user is a member. After table 622 being updated said selected note is displayed in the top row 630 of table 622. Header 628 of table 622 includes in column 624 a path bar 614 that indicates the location(s) of the note displayed in the top row 630 within the tree of notes that comprises all notes of which user identified by identifier 602 is a member. A said location of a note is indicated by a string of characters that comprise subsets of content of successive recursively defined parent notes of said note separated by a delimiting character (e.g a greater-than sign). Navigation interface 600 allows a user to select a content displayed between two delimiting characters in path bar 614 and to cause table 622 to be updated with the display of a subtree that comprises the note which content was selected and all recursively defined child notes of said note and of which said user is a member.

In one embodiment navigation interface 600 also comprises an input text area 632. Input text area 632 is an illustrative embodiment of list of user identifiers 110 in FIG. 1.

FIG. 7 is an illustration of an interface 700 for creating or revising a note in the form of a sample user interface in accordance with an illustrative embodiment. Interface 700 is an illustrative embodiment of a row 630 of table 622 in FIG. 6. Interface 700 allows a user of navigation interface 600 in FIG. 6 to create a new note or to revise an existing note. Interface 700 includes in column 624 input text area 702, button 704 and text area 706. Input text area 702 allows a user to enter or to revise a text. Button 704 allows a user to select one or more files to which navigation interface 600 in FIG. 6 has access. Text area 706 includes the names of one or more files selected using button 704. Interface 700 includes in column 626 input text area 708, button 710 and button 712. Input text area 708 allows a user to enter or to revise a list of user identifiers identifying users of system 100 in FIG. 1. Button 710 allow a user of navigation interface 600 in FIG. 6 to cancel the creation or the revision of a note displayed in interface 700. Button 712 allows a user of navigation interface 600 in FIG. 6 to create or to revise a note which content is the text contained in input text area 702 with the file(s) which name(s) are listed in text area 706, and which members are the users identified by the user identifiers contained in input text area 708.

The advantages of the present invention include, without limitation, that notes can be shared individually and independently of each others while having parent/child relationships between each others. As a result a user can arrange her/his personal notes and her/his notes shared with other users according to a personal tree of notes while the hierarchy between notes shared among two users remains the same in the personal trees of notes of said two users. For the purpose of the description a tree of notes that comprises notes to which a user has access is also referred to as a personal tree of notes of said user. Further, a note to which only one user has access is also referred to as a personal note of said user. A personal tree of notes of a user may include personal notes of said user and notes shared among said user and other users. Further, a tree of notes that comprises only notes to which a same list of users has access is also referred to as a tree of notes common to said list of users.

In a illustrative scenario a user 1 creates a personal note A that is used as a folder name. User 1 further creates a note B that is a child note of note A and that is used for describing an action item that involves user 1, a user 2 and a user 3. Note B is shared among users 1, 2 and 3. User 1 further creates notes C, D, E and F that are child notes of note B and that are used for breaking down note B in sub items that involve one or more users 1, 2 and 3. Note C is a personal note of user 1. Note D is shared among users 1, 2 and 3. Note E is shared among users 1 and 2. Note F is shared among users 1 and 3. In this scenario the personal tree of notes of user 1 comprises notes A, B, C, D, E and F, the personal tree of notes of user 2 comprises notes B, D and E and does not comprises notes A, C and F, the personal tree of notes of user 3 comprises notes B, D and F and does not comprises notes A, C, and E, and the hierarchy between notes A, B, C, D, E and F is the same in the different personal trees of notes of users 1, 2 and 3. Further, in this scenario the tree of notes common to users 1, 2 and 3 comprises notes B and D and does not comprises notes A, C, E and F.

In a further step of this illustrative scenario user 2 adds personal notes or notes shared with other users than users 1 and 3 to the subtree of her/his personal tree of notes that comprises notes B, D and E. Said notes not being shared with users 1 and 3 are not included in the personal trees of notes of users 1 and 3. This allows user 2 to further break down notes B, D and E without informing user 1 and 3.

In a further step of this illustrative scenario user 2 moves note B under an existing note G in his/her personal tree of notes, making said existing note G a parent note of note B in her/his personal tree of notes. This allows user 2 to move the subtree of her/his personal tree of notes that comprises notes B, D and E at a particular location within her/his personal tree of notes. It should be noted that note B has different parent notes in the personal trees of notes of users 1 and 2. Note A is a parent note of note B in the personal tree of notes of user 1 and note G is a parent note of note B in the personal tree of notes of user 2.

In a further step of this illustrative scenario user 3 deletes note D in his/her personal tree of notes. It should be noted that note D was not created by user 3. Note D is removed from the personal tree of notes of user 3 and note D remains in the personal trees of notes of users 1 and 2. The content of note D includes a comment indicating that user 3 has removed him/herself as member of note D.

In a further step of this illustrative scenario user 1 removes user 3 from note F in his/her personal tree of notes. Note F remains in the personal tree of notes of user 3 but, instead of the content and member list of note F, it is displayed in the personal tree of notes of user 3 a text indicating that user 1 has removed user 3 from the note.

While the present invention has been described using a particular combination of hardware and software, it should be recognized that other combinations of hardware and software are also within the scope of the present invention. The present invention may be implemented only in hardware, or only in software, or using combinations thereof. The specification and drawings are, accordingly, to be regarded in an illustrative rather than a restrictive sense. Many variations of the invention will become apparent to those skilled in the art upon review of the disclosure. The scope of the invention should, therefore, be determined not with reference to the above description, but instead should be determined with reference to the pending claims along with their full scope or equivalents.

What is claimed is:

1. A computer-implemented method for editing, storing, sharing and displaying a plurality of notes, the method comprising:
under control of one or more computing devices configured with executable instructions,
entering a new note wherein entering a new note comprises:
identifying a user requesting to store a new note wherein the identifying a user requesting to store a new note comprises:
entering a content of a new note, and
entering zero, one or more identifiers identifying zero, one or more other users with whom to share said new note, and
identifying zero or one second note, which the user requesting to store the new note has permission to access, to be zero or one parent note of said new note;
storing, in response to identifying a user requesting to store a new note, said new note in a database wherein the storing a new note comprises:
storing a content of a note, and
storing the identifier identifying a user requesting to store said note as an identifier identifying a user who has permission to access said note, and
storing the zero, one or more identifiers identifying zero, one or more other users with whom to share said note as zero, one or more identifiers identifying zero, one or more other users who have permission to access said note, and
storing zero or one identifier identifying zero or one parent note of said note;
displaying a plurality of notes which a user has permission to access wherein displaying a plurality of notes which a user has permission to access comprises:
identifying a user requesting to see a plurality of notes which said user has permission to access;
retrieving in the database, in response to identifying a user requesting to see a plurality of notes which said user has permission to access, a plurality of notes which said user has permission to access;
displaying, in response to retrieving in the database a plurality of notes which a user has permission to access, said plurality of retrieved notes to said user, wherein the plurality of retrieved notes are displayed as a hierarchical tree indicative of parent child relationships between notes displayed on the hierarchical tree, and wherein the displaying a note comprises:
displaying either the whole or a part of the content of said note, and
displaying one or more identifiers identifying one or more users who have permission to access said note.

2. The computer-implemented method of claim 1, further comprising:
revising the content of a note wherein revising the content of a note comprises:
identifying a user requesting to revise the content of a note wherein the identifying a user requesting to revise the content of a note comprises:
identifying a note, in the database, which said user has permission to access, and
entering a revised content of said note;
updating in the database, in response to identifying a user requesting to revise the content of a note stored in the database, the stored content of said note with the revised content of said note.

3. The computer-implemented method of claim 2, wherein the storing a new note in the database further comprises storing an identifier identifying the user requesting to store said new note, and wherein the user requesting to store a note is the only user allowed to revise the content of said note.

4. The computer-implemented method of claim 1, further comprising:
identifying a user requesting to delete his/her permission to access a note stored in the database wherein the identifying a user requesting to delete his/her permission to access a note stored in the database comprises identifying a note, in the database, which said user has permission to access;
removing, in response to identifying a user requesting to delete his/her permission to access a note stored in the database, the identifier of said user from the list, stored in the database, of identifiers identifying one or more users who have permission to access said note.

5. The computer-implemented method of claim 4, further comprising:
in response to identifying a user requesting to delete his/her permission to access a note stored in the database,
recursively identifying in the database all child notes of said note which said user has permission to access, and
removing, for each identified child note, the identifier of said user from the list, stored in the database, of identifiers identifying one or more users who have permission to access said child note.

6. The computer-implemented method of claim 4, further comprising adding, in response to identifying a user requesting to delete his/her permission to access a note stored in the database, to the content of said note stored in the database a comment indicating that said user has no more permission to access said note.

7. The computer-implemented method of claim 1, further comprising:
identifying a first user requesting to hide the content of a note to a second user wherein identifying a first user requesting to hide the content of a note to a second user comprises identifying a note, in the database, which both first user and second user have permission to access;
storing in the database, in response to identifying a first user requesting to hide the content of a note to a second user, an attribute of said note indicating that the content of said note must be hidden to the second user, and wherein the displaying of the content of a note to a user displays, instead of the content of a note which an attribute indicates that the content of said note must be hidden to said user, an informative text indicating that the content of said note is hidden to said user.

8. The computer-implemented method of claim 7, wherein the storing a new note in the database further comprises storing an identifier identifying the user requesting to store said new note, and wherein the user requesting to store a note is the only user allowed to hide of the content of said note to another user.

9. The computer-implemented method of claim 1, further comprising:
displaying a note and a plurality of child notes of said note, stored in the database, which a user has permission to access wherein displaying a note and a plurality of child notes of said note, stored in the database, which a user has permission to access comprises:
identifying a user requesting to see a note and plurality of child notes of said note wherein identifying a user requesting to see a note and plurality of child notes of said note comprises identifying a note, in the database, which said user has permission to access;
retrieving in the database, in response to identifying a user requesting to see a note and plurality of child notes of said note, said note and a plurality of child notes, which said user has permission to access, of said note;
displaying, in response to retrieving in the database a note and a plurality of child notes of said note which a user has permission to access, said retrieved notes to said user, wherein the retrieved notes are displayed as a hierarchical tree indicative of parent child relationships between notes displayed on the hierarchical tree, and wherein the displaying a note comprises:
displaying either the whole or a part of the content of said note, and
displaying one or more identifiers identifying one or more users who have permission to access said note.

10. The computer-implemented method of claim 1, further comprising:
displaying a plurality of notes, stored in the database, which two or more users have permission to access wherein displaying a plurality of notes, stored in the database, which two or more users have permission to access comprises:
identifying a user requesting to see a plurality of notes which said user and one or more other users have permission to access wherein identifying a user requesting to see a plurality of notes which said user and one or more other users have permission to access comprises entering one or more identifiers identifying one or more other users;
retrieving in the database, in response identifying a user requesting to see a plurality of notes which said user and one or more other users have permission to access, a plurality of notes wherein said user and said one or more users have permission to access each said note;
displaying, in response to retrieving in the database a plurality of notes which a user and one or more other users have permission to access, said plurality of retrieved notes to said user, wherein the plurality of retrieved notes are displayed as a hierarchical tree indicative of parent child relationships between notes displayed on the hierarchical tree, and wherein the displaying a note comprises:
displaying either the whole or a part of the content of said note, and
displaying one or more identifiers identifying one or more users who have permission to access said note.

11. The computer-implemented method of claim 1, further comprising:
identifying a user requesting to rearrange a note within a displayed hierarchical tree of notes wherein identifying a user requesting to rearrange a note within a displayed hierarchical tree of notes comprises:
identifying a note, in the database, which said user has permission to access, the note selected by said user within a displayed hierarchical tree of notes, and
identifying one new parent note, in the database, which said user has permission to access wherein the new parent note is selected by said user within said displayed hierarchical tree of notes, and
identifying zero or one current parent note, in the database, which said user has permission to access wherein the zero or one current parent note is selected by said user within said displayed hierarchical tree of notes;
in response to identifying a user requesting to rearrange a note within a displayed hierarchical tree of notes, adding to the list, stored in the database, of zero or more identifiers identifying zero or more parent notes of said note the identifier of said new parent note and removing from said list zero or one identifier identifying said zero or one current parent note.

12. A system for editing, storing, sharing and displaying a plurality of notes, the system comprising: an input component; a display; a storage component; a processing component communicatively coupled to the input device, the display, and the storage component, the processing component configured to:
provide a database for storing a plurality of notes;
provide a user interface wherein the user interface is configured to:
identify a user requesting to store a new note wherein the identifying a user requesting to store a new note comprises:
entering a content of a new note, and
entering zero, one or more identifiers identifying zero, one or more other users with whom to share said new note, and
identifying zero or one second note, which the user requesting to store the new note has permission to access, to be zero or one parent note of said new note;
identify a user requesting to see a plurality of notes which said user has permission to access;
display, in response to retrieving in the database a plurality of notes which a user has permission to access, said plurality of retrieved notes to said user, wherein the plurality of retrieved notes are displayed as a hierarchical tree indicative of parent child relationships between notes displayed on the hierarchical tree, and wherein the displaying a note comprises:
displaying either the whole or a part of the content of said note, and
displaying one or more identifiers identifying one or more users who have permission to access said note;
store, in response to identifying a user requesting to store a new note, said new note in the database wherein the storing a new note comprises:
storing a content of a note, and
storing the identifier identifying a user requesting to store said note as an identifier identifying a user who has permission to access said note, and
storing the zero, one or more identifiers identifying zero, one or more other users with whom to share said note as zero, one or more identifiers identifying zero, one or more other users who have permission to access said note, and
storing zero or one identifier identifying zero or one parent note of said note;
retrieve in the database, in response to identifying a user requesting to see a plurality of notes which said user has permission to access, a plurality of notes which said user has permission to access.

13. The system of claim 12,
wherein the user interface is further configured to:
identify a user requesting to revise the content of a note wherein the identifying a user requesting to revise the content of a note comprises:
identifying a note, in the database, which said user has permission to access, and
entering a revised content of said note;
and wherein the processing component is further configured to update in the database, in response to identifying a user requesting to revise the content of a note stored in the database, the stored content of said note with the revised content of said note.

14. The system of claim 13, wherein the storing a new note in the database further comprises storing an identifier identifying the user requesting to store said new note, and wherein the processing component is further configured to allow only the user who has requested to store a note to revise the content of said note.

15. The system of claim 12, wherein the user interface is further configured to identify a user requesting to delete his/her permission to access a note stored in the database wherein the identifying a user requesting to delete his/her permission to access a note stored in the database comprises identifying a note, in the database, which said user has permission to access, and wherein the processing component is further configured to remove, in response to identifying a user requesting to delete his/her permission to access a note stored in the database, the identifier of said user from the list, stored in the database, of identifiers identifying one or more users who have permission to access said note.

16. The system of claim 15, wherein the processing component is further configured to:
in response to identifying a user requesting to delete his/her permission to access a note stored in the database,
recursively identify in the database all child notes of said note which said user has permission to access, and
remove, for each identified child note, the identifier of said user from the list, stored in the database, of identifiers identifying one or more users who have permission to access said child note.

17. The system of claim 15, wherein the processing component is further configured to, in response to identifying a user requesting to delete his/her permission to access a note stored in the database, add to the content of said note stored in the database a comment indicating that said user has no more permission to access said note.

18. The system of claim 12, wherein the user interface is further configured to identify a first user requesting to hide the content of a note to a second user wherein identifying a first user requesting to hide the content of a note to a second user comprises identifying a note, in the database, which both first user and second user have permission to access, and wherein the processing component is further configured to store in the database, in response to identifying a first user requesting to hide the content of a note to a second user, an attribute of said note indicating that the content of said note must be hidden to the second user, and wherein the displaying of the content of a note to a user displays, instead of the content of a note which an attribute indicates that the content of said note must be hidden to said user, an informative text indicating that the content of said note is hidden to said user.

19. The system of claim 18, wherein the storing a new note in the database further comprises storing an identifier identifying the user requesting to store said new note, and wherein the user interface is further configured to allow only the user who has requested to store a note to hide the content of said note to another user.

20. The system of claim 12,
wherein the user interface is further configured to:
identify a user requesting to see a note and plurality of child notes of said note wherein identifying a user requesting to see a note and plurality of child notes of said note comprises identifying a note, in the database, which said user has permission to access;
display, in response to retrieving in the database a note and a plurality of child notes of said note which a user has permission to access, said retrieved notes to said user, wherein the retrieved notes are displayed as a hierarchical tree indicative of parent child relationships between notes displayed on the hierarchical tree, and wherein the displaying a note comprises:
displaying either the whole or a part of the content of said note, and
displaying one or more identifiers identifying one or more users who have permission to access said note;
and wherein the processing component is further configured to retrieve in the database, in response to identifying a user requesting to see a note and plurality of child notes of said note, said note and a plurality of child notes, which said user has permission to access, of said note.

21. The system of claim 12,
wherein the user interface is further configured to:
identify a user requesting to see a plurality of notes which said user and one or more other users have permission to access wherein identifying a user requesting to see a plurality of notes which said user and one or more other users have permission to access comprises entering one or more identifiers identifying one or more other users;
display, in response to retrieving in the database a plurality of notes which a user and one or more other users have permission to access, said plurality of retrieved notes to said user, wherein the plurality of retrieved notes are displayed as a hierarchical tree indicative of parent child relationships between notes displayed on the hierarchical tree, and wherein the displaying a note comprises:
displaying either the whole or a part of the content of said note, and
displaying one or more identifiers identifying one or more users who have permission to access said note;
and wherein the processing component is further configured to retrieve in the database, in response identifying a user requesting to see a plurality of notes which said user and one or more other users have permission to access, a plurality of notes wherein said user and said one or more users have permission to access each said note.

22. The system of claim 12,
wherein the user interface is further configured to identify a user requesting to rearrange a note within a displayed hierarchical tree of notes wherein identifying a user requesting to rearrange a note within a displayed hierarchical tree of notes comprises:
identifying a note, in the database, which said user has permission to access, the note selected by said user within a displayed hierarchical tree of notes, and
identifying one new parent note, in the database, which said user has permission to access wherein the new parent note is selected by said user within said displayed hierarchical tree of notes, and
identifying zero or one current parent note, in the database, which said user has permission to access wherein the zero or one current parent note is selected by said user within said displayed hierarchical tree of notes;
and wherein the processing component is further configured to, in response to identifying a user requesting to rearrange a note within a displayed hierarchical tree of notes, add to the list, stored in the database, of zero or more identifiers identifying zero or more parent notes of said note the identifier of said new parent note and remove from said list zero or one identifier identifying said zero or one current parent note.

23. The system of claim 12, wherein the processing component further comprises a plurality of client components and one or more server components communicatively coupled to a client component via a networking component and wherein the processing component is further configured to run an client server application.

24. The system of claim 23, wherein a server component is configured to run a web server and wherein a client component is configured to run a web browser.
